(19) United States
(12) Patent Application Publication
(10) Pub. No.: US 2009/0228439 A1
(43) Pub. Date: Sep. 10, 2009

(54) INTENT-AWARE SEARCH

(75) Inventors: Dragos A. Manolescu, Kirkland, WA (US); Henricus Johannes Maria Meijer, Mercer Island, WA (US); Laura J. Kern, Seattle, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/044,362

(22) Filed: Mar. 7, 2008

(51) Int. Cl. G06F 17/30

(52) U.S. Cl. 707/3; 707/E17.014

(57) ABSTRACT

A system is provided to improve the relevance of information searches. The system includes a search component to facilitate information retrieval in response to a user's query. An inference component refines the user's query or filters search results associated with the query in view of a determined intent of the user. This can also include a “sensor component” that collects the information fed to the inference component.

### BACKGROUND

Web search engines operate by indexing large numbers of web pages, which are retrieved from the Web itself. These pages are retrieved by a Web crawler (sometimes also known as a spider)—an automated Web browser which follows every link it observes. Exclusions can be made by the use of robots.txt, where the contents of each page are then analyzed to determine how it should be indexed (for example, words are extracted from the titles, headings, or special fields called meta tags). Data regarding web pages are stored in an index database for use in later queries. Some search engines, such as Google, store all or part of the source page (referred to as a cache) as well as information about the web pages, whereas others, such as AltaVista, store every word of every page that are found. This cached page always holds the actual search text since it is the one that was actually indexed, so it can be useful when the content of the current page has been updated and the search terms are no longer in it. This problem might be considered to be a mild form of link-rot, and some search engine's handling of it increases usability by satisfying user expectations that the search terms will be on the returned webpage. This also satisfies the principle of least astonishment since the user normally expects the search terms to be on the returned pages. Increased search relevance makes these cached pages very useful, even beyond the fact that they may contain data that may no longer be available elsewhere.

When a user enters a query into a search engine (typically by using key words), the engine examines its index and provides a listing of best-matching web pages according to its criteria, usually with a short summary containing the document's title and sometimes parts of the text. Most search engines support the use of the Boolean operators AND, OR and NOT to further specify the search query. Some search engines provide an advanced feature called proximity search which allows users to define the distance between keywords.

The usefulness of a search engine depends on the relevance of the result set it gives back. While there may be millions of web pages that include a particular word or phrase, some pages may be more relevant, popular, or authoritative than others. Most search engines employ methods to rank the results to provide the “best” results first. How a search engine decides which pages are the best matches, and what order the results should be shown in, varies widely from one engine to another and typically represents each engine's competitive advantage over others. The methods also change over time as Internet usage changes and new techniques evolve.

As platforms are shifting from the desktop to cloud-based network services, people have access to volumes of information larger than they were able to access just a few years ago. Consequently they are increasingly relying on search to find the information relevant to the task at hand. As search is becoming ubiquitous, people use the technology from many different contexts. While in the past users may have used a search engine to look up a word when writing a document, today they fire off searches while performing a wide range of activities, in many different applications. For example, composing emails in an email client; attending a meeting and taking notes in document application; writing C# code in a software development application; conversing with someone else in an instant messenger client; looking for a restaurant while driving in a car using a mobile phone; and so forth. Consequently, the type of information users are looking for is contextual in nature.

In one example, consider a developer building a service mash-up application, where the developer is working in a design platform application and they start looking for a dictionary service. Using a search engine such as Live Search, they might enter “dictionary web service” as the query string. The search engine produces search results 800 such as shown in Prior Art FIG. 8.

In this particular context, the results about the dictionary definition of a web service are not useful for the user, and as such represent noise that the user needs to filter out either by visually analyzing and ignoring these results, or by tweaking the query and resubmitting. As a consequence, the developer perceives the search engine as returning irrelevant results, and the burden is on the user to make additional efforts to obtain the quality of results they're looking for.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Inference components are employed to determine a user's intent when performing a search. By determining intent, a relevant or more informed search can be achieved where queries are modified on the front end in view of the intent and/or results are filtered or modified on the back end in view of the intent. Various inputs can be analyzed by the inference components for clues about intent such as the user's current or ambient context, calendar, social network, rules or policies, user profiles, and so forth that can be utilized to refine a user's information search into the most efficient search possible. For example, the current context for a user may be in a software development environment where an e-mail is received asking a particular question about some unknown problem or question in the development. When the user attempts to search for an answer, front end or back end components can be augmented with the knowledge regarding the user's actual intention for performing the respective search. In this example, not only is the user concerned with general search results relating to a software development environment but more so to results that are tuned or focused to the particular task or question at hand that can be automatically derived from e-mail or other sources. By tuning search capabilities with the user's inferred intent, search results can be presented that are closer to the user's goals and thus provide a better search experience.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating a system for determining intent during information searches.

FIG. 2 is a block diagram that illustrates an intent inference engine for processing intent-aware searches.

FIG. 3 illustrates and example search system that employs intent-based processing.

FIG. 4 illustrates example system for automatically determining and processing intent.

FIG. 5 illustrates an example user profile that can be employed to control how intent is determined and how search results are processed.

FIG. 6 illustrates an exemplary activity monitoring system for determining a user's intent.

FIG. 7 illustrates a flow diagram that describes an intent-based search process.

FIG. 8 illustrates a prior art listing of returned search results.

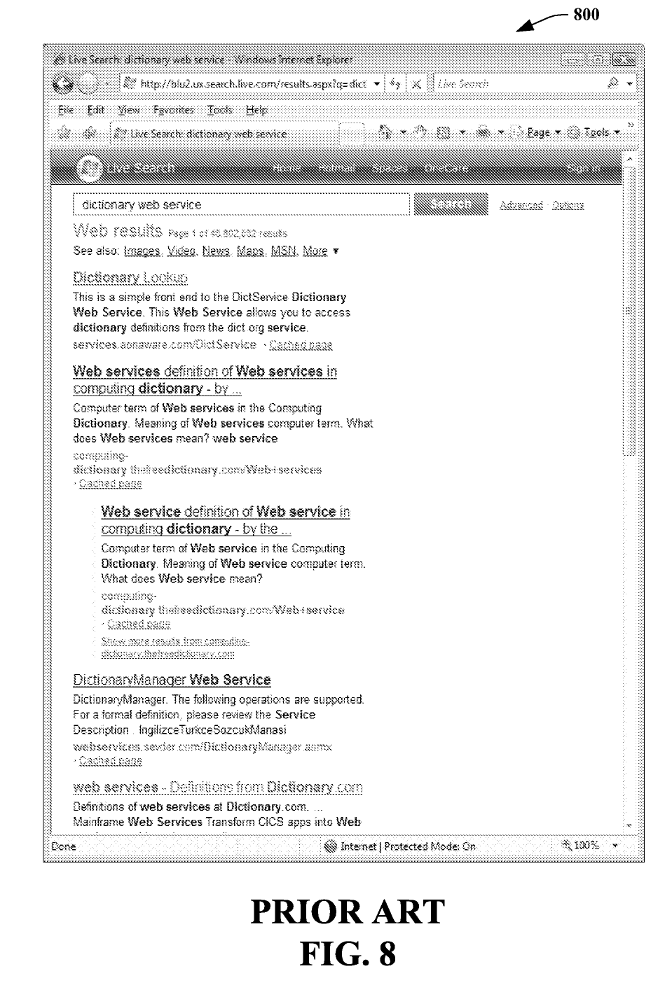

FIG. 9 is a schematic block diagram illustrating a suitable operating environment.

FIG. 10 is a schematic block diagram of a sample-computing environment.

### DETAILED DESCRIPTION

Systems and methods are provided for automatically determining a user's intent in order to facilitate efficient information retrieval. In one aspect, a system is provided to facilitate information searches. The system includes a search component to facilitate information retrieval in response to a user's query. An inference component refines the user's query or filters search results associated with the query in view of a determined intent of the user.

As used in this application, the terms “component,” “search,” “engine,” “query,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g. data from one component interacting with another component in a local system, distributed system, and/or across a network such as the Internet with other systems via the signal).

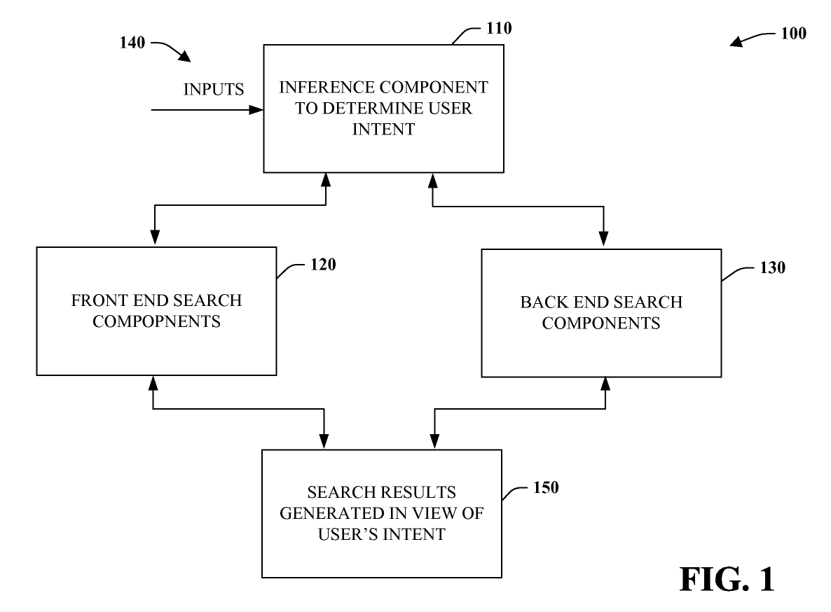

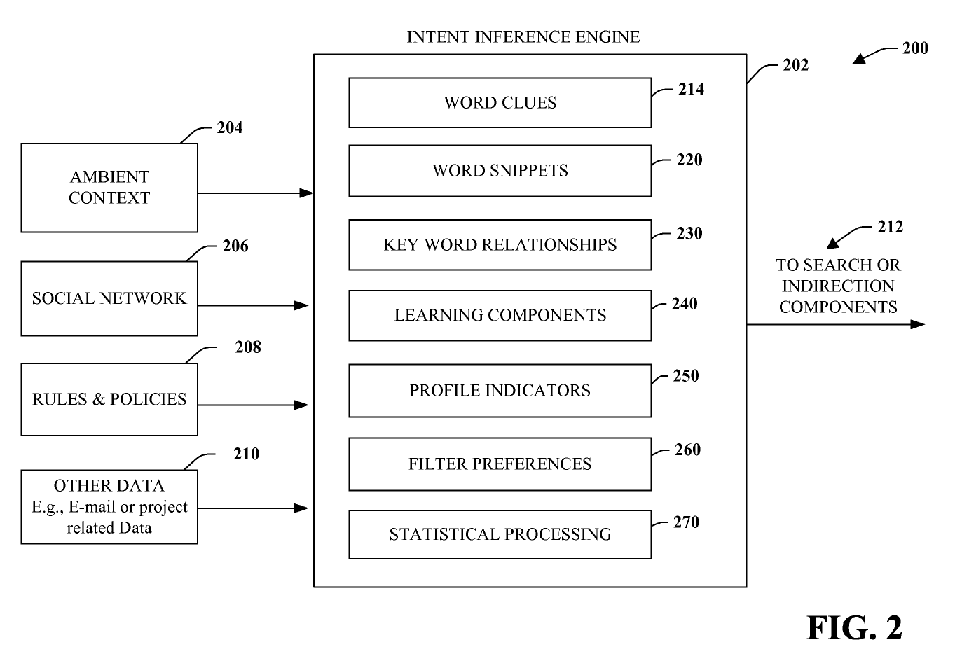

Referring initially to FIG. 1, a system 100 is illustrated for determining a user's intent when performing information searches. An inference component 110 (also referred to as inference engine) is employed to determine a user's intent when performing a search. By determining intent, a relevant or more-informed search can be achieved where queries are modified via front end search components 120 in view of the intent and/or results are filtered or modified via back end search components 130 in view of the intent. Various inputs 140 can be analyzed by the inference component 110 for clues about intent such as the user's current or ambient context, calendar, social network, rules or policies, user profiles, and so forth that can be utilized to refine a user's information search into the most relevant search possible. The inputs are described in more detail below with respect to FIG. 2. As shown, search results 150 are generated based off the determined intent. It is noted that the inference component 110 can be applied as a pluggable mechanism and can be associated with substantially any type of application. Thus, even though searching applications such as search engines can be employed other knowledge search systems associated with a given application can also be enhanced by adapting the inference component 110 with such facilities.

In one particular example, the current context for a user may be in a software development environment where an instant message or phone call is received asking a particular question about some unknown problem or question in the development. When the user attempts to search for an answer, the front end components 120 or the back end components 130 can be augmented with the knowledge regarding the user's actual intention for performing the respective search. In this example, not only is the user concerned with general search results relating to a software development environment but more so to results that are tuned or focused to the particular task or question at hand that can be automatically derived from the respective communication or other sources as will be described in more detail below. By modifying search capabilities with the user's inferred intent, search results 150 can be presented that are closer to the user's goals and thus provide a more efficient search experience.

Other aspects for the system 100 include refining searches using existing temporal information. This may include inferring what a developer or user may want to do in the future. In one specific example, the inference component 110 can be employed with auto-complete functions that attempt to determine the type of search that the user desires to perform (e.g., type in a few letters or words and the phrase is automatically completed based in part on the inferred intent). Multi-step inferences can be achieved where the output of one inference is fed to another component for subsequent refinement of a decision regarding the user's ultimate intentions. This may include providing automated dialog inputs via user interfaces that further seek to understand what a user's intent is in view of possible uncertainties. Thresholds can also be established where if the system 100 is certain above a given probability threshold, then automated actions regarding searches can commence without further user inputs to resolve uncertainty. The inputs 140 can include exploring social networks, analyzing phone or other electronic conversations, or employing a history of user responses to determine and refine intentions over time.

In general, the system 100 enables capturing a search context, where data is collected regarding user's most likely intention such as current contextual information (such as the user's activity and the applications used most recently). This may include mapping intent data or other contextual information to query refinements. For some applications, the intent may be known (e.g., development environment, spreadsheet application, email client); for others the user may want to specify it (e.g., when I use FooBaz, I am dealing with digital photos). This can also include augmenting a search query with intent information automatically or modifying search results in view of the intent. Also, the determined intent information can be provided in a manner that is transparent to the user. In another aspect, the system 100 allows using the determined intent information to improve the perceived relevance of the results. In effect, down-rank the results that, while relevant to the context-free query string, are irrelevant given the currently determined intentions of the user.

It is noted that data for the system 100 can be gleaned and analyzed from a single source or across multiple data sources, where such sources can be local or remote data stores or databases. This can include files or data structures that maintain states about the user and can be employed to determine future states. These can be past action files for instance that store what a user has done in the past and can be used by intelligent components such as classifiers to predict future actions. Related aspects can be annotating or processing metadata that could be attached to e-mails or memoranda for example. Data can be employed to facilitate interpersonal sharing, trusted modes, and context/intent sharing for example. Data which can be stored can also be employed to control virtual media presentations and control community interactions such as the type of interface or avatar that may be displayed for a respective user on a given day. Interactive data can be generated in view of the other data.

It is further noted that users can add, define, modify, specialize, or personalize the inference, filter, front or back end search components, mining components, intent extraction components, re-shaper components, monitoring components, or learning components described herein. For instance, a word processing application can have automatic spam filtering based on Bayesian learning, but users can also add their own rules. In another aspect, the system 100 can improve the quality of the intentional search based on payments. Thus, users receive general “developer intent inference” for free for example, but if they pay a fee, the intent inference can be specific for a team, for instance, if one searches for bugs, it can take a developer's code base into account. Another aspect is that when the user's intent is determined, the system 100 can also present highly targeted advertisements. For instance, based on the intent and history of a developer, the system 100 can show an advertisement for a specialized tool (e.g., a code re-factoring tool) specific for the programming language and environment of the user.

Referring now to FIG. 2, a data generation and inference system 200 is illustrated. As shown, an intent inference engine 202 processes various inputs to determine a user's current intent which can be employed to further augment and/or refine search systems. In one aspect, ambient context 204 is analyzed. This can include background sounds, e-mails, phone conversations, calendar events, facial recognition, the application(s) that the user is actively using, and substantially any type of clue that can be analyzed to determine the user's intentions. At 206, a user's social network can be analyzed. A message from a mountain climbing friend is going to have a different impact than a recent message from a member of the development team. Thus, any recent activity searching could be influenced by the social network and associated contacts.

At 208, rules and policies can be employed to further refine intentions. For example, a user could specify that when a certain application is open on their desktop that their intentions relate to software development. As can be appreciated a plurality of rules or controls can be provided to further help the system determine intent. At 210, substantially any data the user interacts with can be used for intent including opened applications, e-mails, calendar information, instant messages, voice data, biorhythmic data and so forth. The following description provides some elementary examples of analysis that may be applied by the inference engine 202. It is to be appreciated that the list is exemplary in nature and not considered exhaustive of the types of data and/or analysis that can be performed to determine such intent.

The intent inference engine 202 analyzes the inputs 204-210 and automatically produces output 212 that can be employed to refine or modify searches with a user's determined intent. The inference component 202 shows example factors that may be employed to analyze a given user's current circumstances to produce the output 212.

Proceeding to 214, one aspect for analyzing data from the inputs 204-210 (also can be real time analysis such as received from a wireless transmission source) includes word or file clues 214. Such clues 214 may be embedded in a document or file and give some indication or hint as to the type of data being analyzed. For example, some headers in file may include words such as summary, abstract, introduction, conclusion, and so forth that may indicate the generator of the file has previously operated on the given text. Likewise, the file may have been tagged already by the user, such as “proposal,” “patent,” and so on. These clues 214 may be used by themselves or in addition to other analysis techniques for generating the output 212. For example, merely finding a word summary wouldn't preclude further analysis and generation of output 212 based on other parts of the analyzed data from 212. In other cases, users can control analysis by stipulating that if such words are found in a document that the respective words should be given more weight for the output 212 which may limit more complicated analysis described below.

At 220, one or more word snippets may be analyzed. This can include processes such as analyzing particular portions of a document to be employed for generation of the output 212. For example, analyze the first 20 words of each paragraph, or analyze the specified number of words at the beginning, middle and end of each paragraph for later use in automatic embedding of contextual data. Substantially any type of algorithm that searches a document for clusters of words that are a reduced subset of the larger corpus can be employed. Snippets 220 can be gathered from substantially any location in the document and may be restrained by user preferences or filter controls.

At 230, the intent inference component 202 may employ key word relationships to determine output 212. Key words may have been employed during an initial search of a data store or specified specifically to the inference component 202 via a user interface (not shown). Key words 230 can help the inference component 202 to focus its automated analysis near or within proximity to the words so specified. This can include gathering words throughout a document or file that are within a sentence or two of a specified keyword 230, only analyzing paragraphs containing the keywords, numerical analysis such as frequency the key word appears in a paragraph. Again, controls can modify how much weight is given to the key words 230 during a given analysis.

At 240, one or more learning components 240 can be employed by the inference component 202 to generate output 212. This can include substantially any type of learning process that monitors activities over time to determine a user's intentions for subsequent search applications. For example, a user could be monitored for such aspects as what applications they are using, where in a document they analyze first, where their eyes tend to gaze, how much time the spend reading near key words and so forth, where the learning components 240 are trained over time to analyze in a similar nature as the respective user. Also, learning components 240 can be trained from independent sources such as from administrators who generate information, where the learning components are trained to automatically generate data based on past actions of the administrators. The learning components 240 can also be fed with predetermined data such as controls that weight such aspects as key words or word clues that may influence the inference component 212. Learning components 240 can include substantially any type of artificial intelligence component including neural networks, Bayesian components, Hidden Markov Models, Classifiers such as Support Vector Machines and so forth.

At 250, profile indicators can influence how output is generated at 212. For example, controls can be specified in a user profile described below that guides the inference component 202 in its decision regarding what should and should not be included in the output 212. In a specific example, a business user may not desire to have more complicated mathematical expressions contained in output 212 where an Engineer may find that type of data highly useful in any type of output. Thus, depending on how preferences 250 are set in the user profile, the inference component 202 can include or exclude certain types of data (indicating intent) at 212 in view of such preferences.

Proceeding to 260, one or more filter preferences may be specified that control output generation at 212. Similar to user profile indicators 250, filter preferences 260 facilitate control of what should or should not be included in the output 212. For example, rules or policies can be setup where certain words or phrases or data types are to be excluded from the output 212. In another example, filter preferences 260 may be used to control how the inference component 202 analyzes files from a data store or other sources. For instance, if a rule were setup that no mathematical expression were to be included in the output 212, the inference component 202 may analyze a given paragraph, determine that it contains mostly mathematical expressions and skip over that particular paragraph from further usage in the output 212. Substantially any type of rule or policy that is defined at 260 to limit or restrict output 212 or to control how the inference component 202 processes a given data set can be employed.

At 270, substantially any type of statistical process can be employed to generate intent-based output 212 for a searching application. This can include monitoring what ensemble of applications the user is actively using and how they switch focus between them. As noted previously, other factors than the examples shown at 214-270 can be employed by the intent inference engine 202 for analysis.

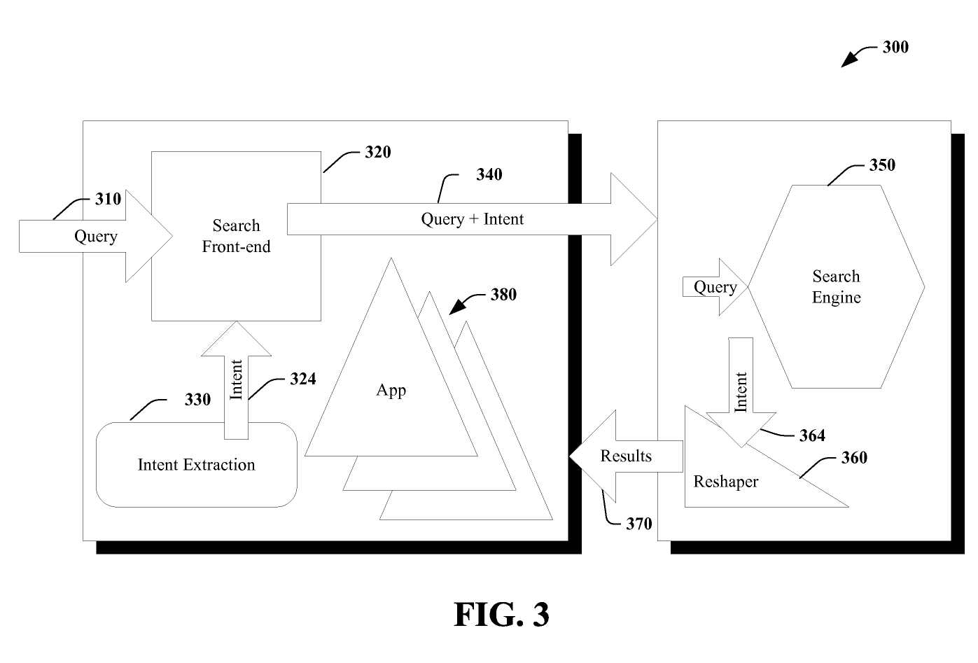

Turning to FIG. 3, an example system 300 is illustrated that employs intent-based searches. A query 310 is input to a search front end component 320, where the front end component receives intent data 324 from an intent extraction component 330 (e.g., intent inference engine). A query is reformulated in view of the intent 340 and processed by a search engine. After initial searches, a reshaper 360 may also employ intent 364 for back end search refinements in view of the user's determined intent. Search results 370 that have been generated at least in part on the user's determined intent are returned to one or more applications 380 that may display or use the results.

In general, Intent-driven search employs elements that provide at least some of the following functionality:

1. Extracting intent, such as user activity and the currently running applications. This could be accommodated by a standard operating system component such as the task manager.

2. Integrating the captured intent 324 with the search front end 320. This could be a browser component that packages the extracted intent 324 along with the search query 310 and sends the augmented, intent-aware query 340 to the search engine 350.

3. Shaping the search results at 360 to take into account the intent information 364. This can be implemented by a search engine component 350 that processes the intent-free query results to improve their perceived relevance. The intent be used to filter out search results 370, as well as to group results based on activities. Since users have typically many applications 380 open concurrently, it is non-obvious if there is a single “expected” intent for search results. Thus, profiles, user controls, or dialog feedback can be employed to further refine such intent.

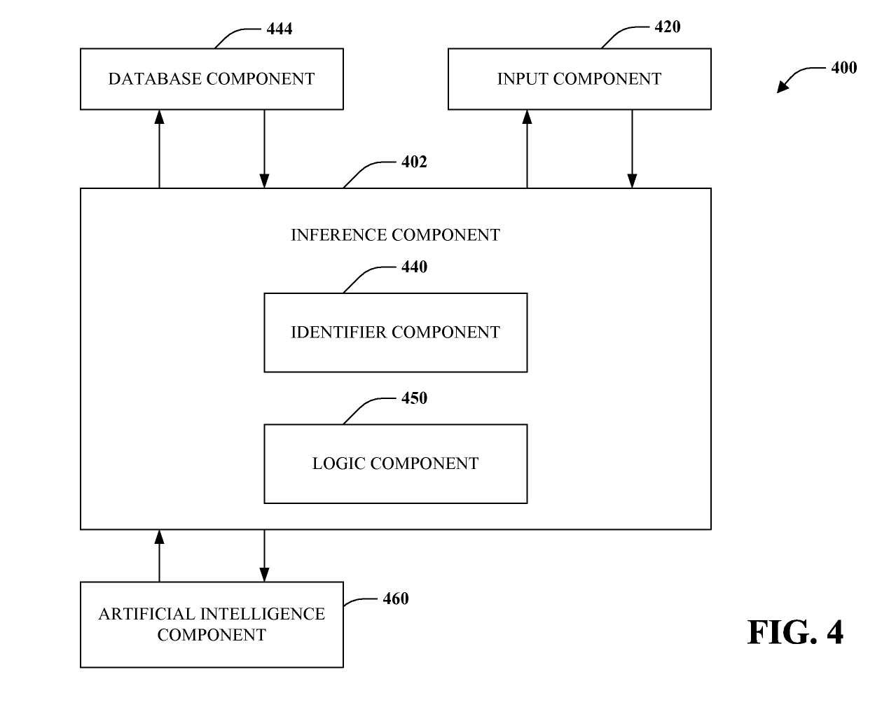

Referring now to FIG. 4, an example detailed system 400 employing an inference component 402 is illustrated, where the system can automatically determine intent data as refinements for a search application. The inference component 402 receives a set of parameters from an input component 420. The parameters may be derived or decomposed from a specification provided by the user and parameters can be inferred, suggested, or determined based on logic or artificial intelligence. An identifier component 440 identifies suitable control steps, or methodologies to accomplish the determination of a particular data item for intent in accordance with the parameters of the specification. It should be appreciated that this may be performed by accessing a database component 444, which stores one or more component and methodology models. The inference component 402 can also employ a logic component 450 to determine which data component or model to use when augmenting a query and/or generated results.

When the identifier component 440 has identified the components or methodologies and defined models for the respective components or steps, the inference component 402 constructs, executes, and modifies queries/results upon an analysis or monitoring of a given application. In accordance with this aspect, an artificial intelligence component (AI) 460 automatically generates intent data by monitoring present user activity. The AI component 460 can include an inference component (not shown) that further enhances automated aspects of the AI components utilizing, in part, inference based schemes to facilitate inferring data from which to augment an application. The AI-based aspects can be affected via any suitable machine learning based techniques or statistical-based techniques or probabilistic-based techniques or fuzzy logic techniques. Specifically, the AI component 460 can implement learning models based upon AI processes (e.g., confidence, inference). For example, a model can be generated via an automatic classifier system.

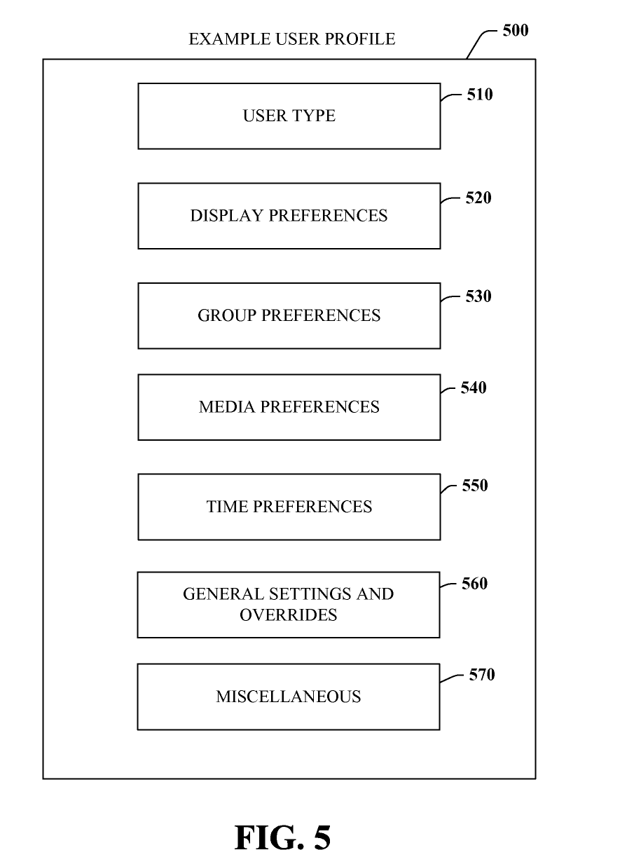

Proceeding to FIG. 5, an example user profile 500 is illustrated that can be employed to control how intent is determined and how search results are processed. In general, the profile 500 allows users to control the types and amount of information that may be captured. Some users may prefer to receive more information associated with a given data context whereas others may desire information generated under more controlled or narrow circumstances. The profile 500 allows users to select and/or define options or preferences for generating search data. At 510, user type preferences can be defined or selected. This can include defining a class for a particular user such as adult, child, student, professor, teacher, novice, and so forth that can help control how much and the type of data that is created for a respective application. For example, a larger or more detailed corpus of data can be generated for a novice user over an experienced one.

Proceeding to 520, the user may indicate one or more display preferences. For instance, the user may select how results are to be displayed such as via hovering over portions of a document or captured as part of a user interface where the results are selected from a menu for example. At 530, group preferences may be defined. This can include defining members of a user's that can be employed to control how documents are updated and social networks are processed such as the environment from which to share and/or receive information. Other aspects could include specifying media preferences at 540, where users can specify the types of media that can be included and/or excluded form a respective search. For example, a user may indicate that data is to include text and thumbnail images only but no audio or video clips are to be provided.

Proceeding to 550, time preferences can be entered. This can include absolute time information such as only perform data generation activities on weekends or other time indication. This can also include calendar information and other data that can be associated with time or dates in some manner. Proceeding to 560, general settings and overrides can be provided. These settings at 560 allow users to override what they generally use to control embedded information. For example, during normal work weeks, users may screen out detailed data for all files generated for the week yet the override specifies that the results are only to be generated on weekends. When working on weekends, the user may want to simply disable one or more of the controls via the general settings and overrides 560. At 570, miscellaneous controls can be provided. These can include if then constructs or alternative languages for more precisely controlling how algorithms are processed and controlling respective data result formats.

The user profile 500 and controls described above can be updated in several instances and likely via a user interface that is served from a remote server or on a respective mobile device if desired. This can include a Graphical User Interface (GUI) to interact with the user or other components such as any type of application that sends, retrieves, processes, and/or manipulates data, receives, displays, formats, and/or communicates data, and/or facilitates operation of the system. For example, such interfaces can also be associated with an engine, server, client, editor tool or web browser although other type applications can be utilized.

The GUI can include a display having one or more display objects (not shown) for manipulating the profile 500 including such aspects as configurable icons, buttons, sliders, input boxes, selection options, menus, tabs and so forth having multiple configurable dimensions, shapes, colors, text, data and sounds to facilitate operations with the profile and/or the device. In addition, the GUI can also include a plurality of other inputs or controls for adjusting, manipulating, and configuring one or more aspects. This can include receiving user commands from a mouse, keyboard, speech input, web site, remote web service and/or other device such as a camera or video input to affect or modify operations of the GUI. For example, in addition to providing drag and drop operations, speech or facial recognition technologies can be employed to control when or how data is presented to the user. The profile 500 can be updated and stored in substantially any format although formats such as XML may be employed to store summary information.

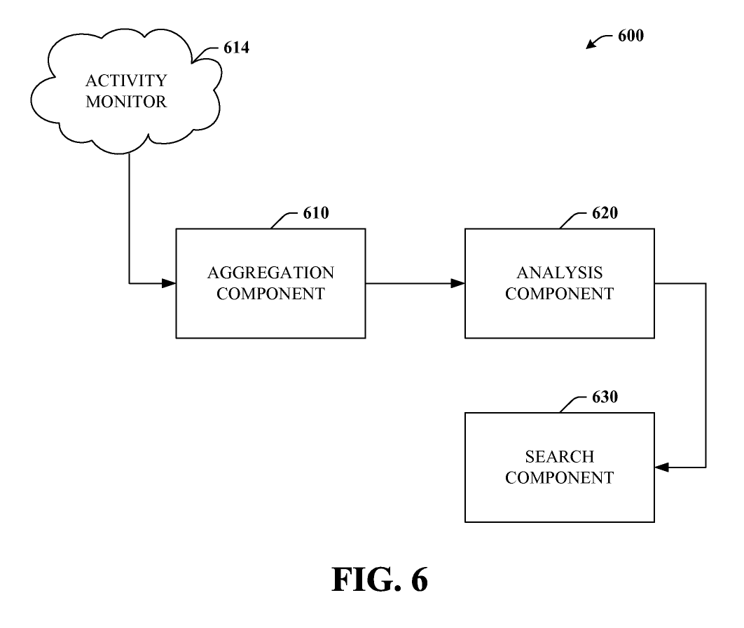

Referring to FIG. 6, an exemplary activity monitoring system 600 is illustrated that facilitates determining intent that may be relevant for a given search application. The system 600 includes an aggregation component 610 that aggregates activity data from a monitor component 614 and corresponding user data from local and/or remote users. The monitoring component 614 can monitor and collect activity data from one or more users on a continuous basis, when prompted, or when certain activities are detected (e.g., a particular application or document is opened or modified). Activity data can include but is not limited to the following: the application name or type, document name or type, activity template name or type, start/end date, completion date, category, priority level for document or matter, document owner, stage or phase of document or matter, time spent (e.g., total or per stage), time remaining until completion, and/or error occurrence. User data about the user who is engaged in such activity can be collected as well. This can include the user's name, title or level, certifications, group memberships, department memberships, experience with current activity or activities related thereto.

An analysis component 620 can process aggregated data 610 and then group it according to which users appear to be working on the same project or are working on similar tasks. In a work-related setting, this information can be displayed on a user interface for a group manager, for example, to readily view. Thus, the group manager can view the progress and/or performance data of the people he is managing. Even more so, this information can be accessed locally or remotely by group members (e.g., via web link). When some group members are located in different cities, states, or countries and across time zones, the ability to view each other's activity data and progress can enhance activity coordination and overall work experience. This type information can also be employed for intent-based data mining where search experiences of one or more users is mined to determine search suggestions for a single user or small subset of users.

Individual users (not associated with a group) can benefit from mined information as well. In particular, they can gauge their progress or skill level by comparing their progress with other users who are working on or who have worked on the same or similar activity. They can also learn about the activity by viewing other users' comments or current state with regard to the activity. In addition, they can estimate how much more time is required to complete the activity based on the others' completion times which can be helpful for planning or scheduling purposes. All such activity data can be associated with an application for later or real time viewing by users. Such data can be augmented in accordance with search results that may be related to such activities or groups. In another aspect, a search system is provided. The system includes means for monitoring user activities over time (activity monitor 614) and means for determining a user's intentions from the monitored activities (inference component 110 from FIG. 1). This can also include means for modifying a search query or search results in view of the determined intentions (search component 630).

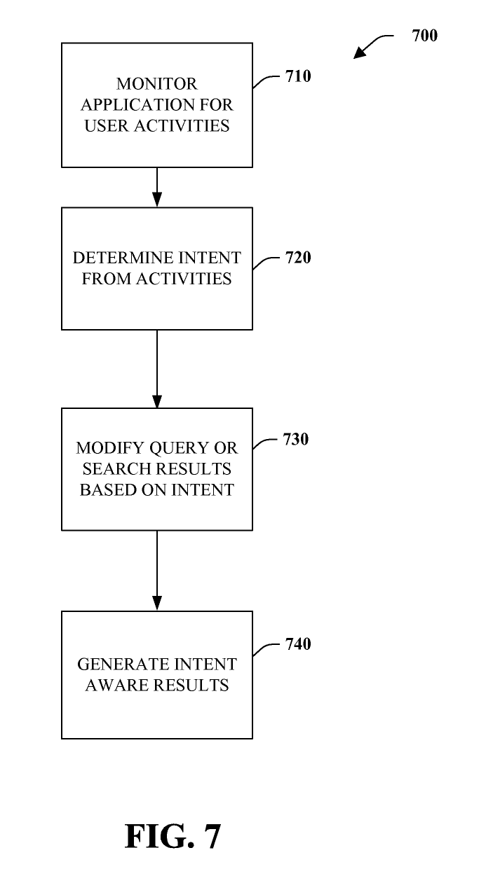

Referring now to FIG. 7, a process 700 illustrates intent-based searching. While, for purposes of simplicity of explanation, the process is shown and described as a series or number of acts, it is to be understood and appreciated that the subject processes are not limited by the order of acts, as some acts may, in accordance with the subject processes, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject processes described herein.

Proceeding to 710 of the process 700, applications are monitored for user activity. The monitoring comprises tracking the applications' types (e.g., development environments, text editors, email clients) and activities, which can include e-mails, meeting notes, audio files where an application is discussed, video data, presentation data, and substantially any type of data that is associated with a given application. In a development environment, this could include all the checkin log messages relating to source code, in addition to follow-up e-mails related to the code, for example. At 720, intent is determined from the monitored activities of 710. This can include training learning components over time or employing more direct methods such as specifying intent by rule or policy. Intent can also be mined from groups of users and employed to augment searches for a single user. At 730, search queries are modified in view of the determined intent. This can include adding or removing terms in a query, modifying terms in a query, changing Boolean operators to be more in line with the user's intent and so forth. This can also include modifying search results in view of intent. This includes pruning of results, re-ranking results, filtering results, or other modifications. Another option is to package these hints with the query without modifying the query at all. At 740, intent-aware results are generated. Thus, after the user's current intent has been determined search results are generated that have been focused to the user's current intent while mitigating extraneous results that are contrary to such intent. This can even include generating dialog sessions during the process 700 to further refine present intentions in view of any uncertainty or other probability that may be involved.

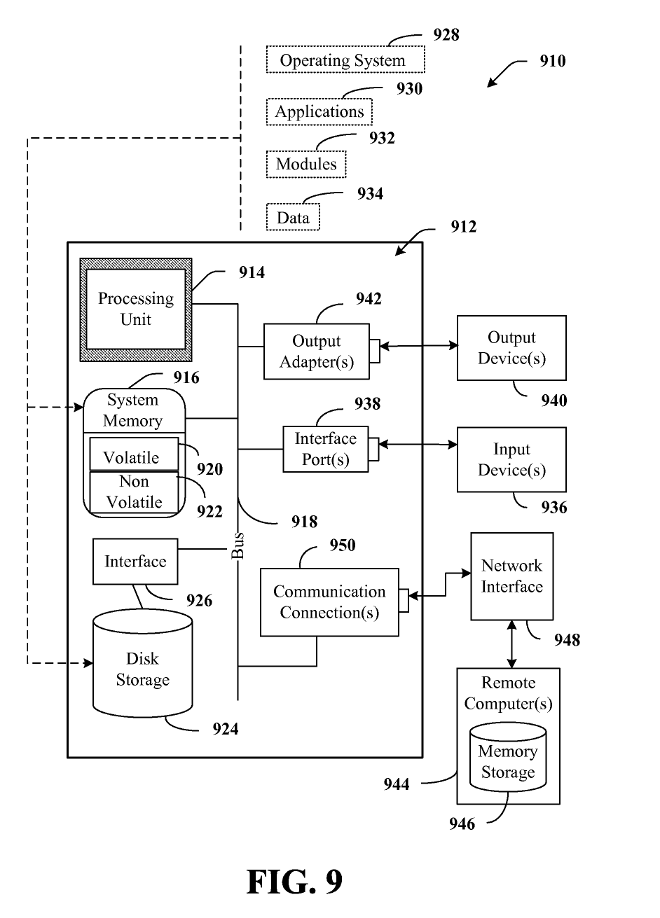

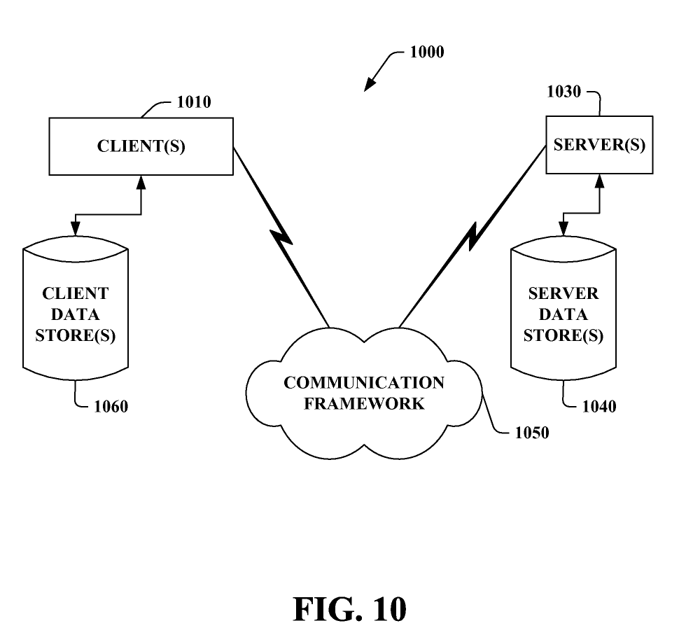

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that performs particular tasks and/or implements particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 9, an exemplary environment 910 for implementing various aspects described herein includes a computer 912. The computer 912 includes a processing unit 914, a system memory 916, and a system bus 918. The system bus 918 couple system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 64-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912 and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g. threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operably connected to one or more client data store(s) 1060 that can be employed to store information local to the client(s) 1010. Similarly, the server(s) 1030 are operably connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system to facilitate information searches, comprising:
a search component to facilitate information retrieval in response to a user's query; and
an inference component to process the user's query or to filter search results associated with the query in view of a determined intent of the user.

2. The system of claim 1, the inference component is applied as a plug-in component to substantially any type of application.

3. The system of claim 2, further comprising a profile component that includes a user type component, a preferences component, a group preferences component, a media component, a time component, a calendar component, or a general settings component.

4. The system of claim 1, further comprising a filter component to control data generated by the inference component.

5. The system of claim 1, the inference component analyzes ambient context, social networks, rules or policies to determine in part a user's intent.

6. The system of claim 1, the inference component further comprises a word clues component, a word snippets component, a key word component, a learning component, a profile component, an advertising component, or a statistical component.

7. The system of claim 1, further comprising a front end or back end search component that is modified in view of a user's determined intent.

8. The system of claim 1, further comprising a mining component that analyzes groups of user's for intent-based queries.

9. The system of claim 8, the intent-augmented queries are applied to a single user or a subset of users.

10. The system of claim 1, further comprising an intent extraction component to augment a front end search component.

11. The system of claim 10, further comprising a search engine that searches for information based upon a query processed in part by a user's determined intent.

12. The system of claim 11, further comprising a re-shaper component that employs a user's determined intent to modify one or more search results.

13. The system of claim 1, further comprising a monitoring component to collect data relating to a user's intentions over time.

14. The system of claim 13, further comprising a component to independently extend functionality of at least one of an inference component, a filter component, a front or back-end search component, a mining component, an intent extraction component, a re-shaper component, a monitoring component, or a learning component.

15. The system of claim 13, further comprising a learning component to determine the user's intentions over time.

16. The system of claim 15, further comprising a feedback component to enable user's to resolve uncertainty regarding inferred intent.

17. The system of claim 1, further comprising an auto-complete function that is modified in view of a user's determined intent.

18. An automated searching method, comprising:
automatically monitoring user activities over time;
inferring a user's likely intentions from the monitored activities; and
automatically modifying a search query in view of the determined intentions.

19. The method of claim 18, further comprising modifying one or more search results in view of the determined intentions.

20. A search system, comprising:
means for monitoring user activities over time;
means for inferring a user's intentions from the monitored activities; and
means for modifying a search query or search results in view of the determined intentions.
